(19) United States
(12) Patent Application Publication
(10) Pub. No.: US 2004/0148525 A1
(43) Pub. Date: Jul. 29, 2004

(54) Software providing system, software providing apparatus and method, recording medium, and program

(75) Inventors: Taku Aida, Kanagawa (JP); Tomihiko Nakajima, Tokyo (JP); Akinori Iida, Kanagawa (JP); Yoshinobu Endo, Tokyo (JP)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Sony Corporation, Tokyo (JP)

(21) Appl. No.: 10/699,984

(22) Filed: Nov. 3, 2003

(30) Foreign Application Priority Data
Nov. 18, 2002 (JP) 2002-333489

(51) Int. Cl. G06F 11/30; G06F 9/445; G06F 9/44

(52) U.S. Cl. 713/201; 717/176; 717/171

(57) ABSTRACT

A first client device is allowed to run software that a second client device owned by the same user has been allowed to run. At that time, a user ID of the user, a device ID of the second client device, and a software ID of the software, registered in association with each other, are deleted from a database server, and the software ID of the software is registered in association with the user ID of the user and the device ID of the first client device. When it has been verified that the software ID is registered in association with the user ID of the user and the device ID of the first client device, a license key is issued to the first client device.

### CROSS-REFERENCE TO RELATED APPLICATIONS

The present application claims priority from Japanese Application No. 2002-333489 filed Nov. 18, 2002, the disclosure of which is hereby incorporated by reference herein.

### BACKGROUND OF THE INVENTION

The present invention relates to software providing systems, software providing apparatuses and methods, recording media, and programs. More specifically, the present invention relates to a software providing system, a software providing apparatus and method, a recording medium, and a program that allow an electronic device of a user to run software that another electronic device of the same user has been allowed to run.

FIG. 1 shows an example configuration of a software providing system according to the related art, disclosed, for example, in Japanese Unexamined Patent Application Publication No. 2001-357156.

When software SA, purchased by downloading via a network 2, is installed on, for example, a client device 1-1 of a user A, the client device 1-1 sends a device ID thereof to a software providing server 3 via the network 2, requesting issuance of a license key that is required to run the software SA.

The software providing server 3, upon receiving the request for issuance of a license key, queries a database server 6 as to whether the device ID transmitted from the client device 1-1 is registered in the database server 6. If the device ID is registered, that is, if the client device 1-1 is successfully authenticated, the software providing server 3 requests, via the network 2, a license server 4 to issue a license key. In response to the request from the software providing server 3, the license server 4 issues a license key, and sends the license key to the client device 1-1 via the network 2.

The client device 1-1, using the license key received from the license server 4, runs the software SA purchased from the software providing server 3.

Since the client device 1-1 is authenticated on the basis of the device ID and a license key is issued based on the result of authentication as described above, illegitimate use of the software SA is prohibited.

According to the related art, however, if the user A now wishes to run the software SA that the client device 1-1 has been allowed to run on another client device 1-2 of the user A, the user A has to purchase the software SA again for the client device 1-2, raising the cost for using the software SA.

### SUMMARY OF THE INVENTION

The present invention has been made in view of the situation described above, and an object thereof is to allow a client device of a user to run software that another client device of the same user has been allowed to run.

The present invention, in one aspect thereof, provides a system for providing software, including a server operable to provide software via a network to a plurality of electronic devices; and at least two electronic devices, each of the at least two electronic devices being identified by device identification information registered in association with user identification information identifying a single user of the at least two electronic devices. Each of the at least two electronic devices includes first requesting means for sending the user identification information and the device identification information for the electronic device, and software identification information for selected software, to the server to request that the selected software be provided; installing means for installing the selected software provided from the server; second requesting means for sending the software identification information for the selected software, the user identification information, and the device identification information for the electronic device to the server to request that a license required to run the selected software be generated based on predetermined license generating information and be provided to the electronic device; running means for running the selected software using the license; and third requesting means for requesting that the server transfer the selected software to another of the at least two electronic devices. The server includes registering means for registering the software identification information for the selected software in association with the user identification information and the device identification information for the electronic device on condition that the user identification information and the device identification information for the electronic device have been registered in association with each other; providing means for providing the selected software to the electronic device; generating means for generating the license when the software identification information for the selected software, the user identification information, and the device identification information for the electronic device have been registered in association with each other; and transferring means for, upon a request by the third requesting means of the electronic device to transfer the selected software to the another electronic device, deleting the software identification information for the selected software and the user identification information and the device identification information registered in association with the software identification information, and registering the software identification information for the selected software in association with the device identification information for the another electronic device and the user identification information.

According to the system for providing software of the present invention, at an electronic device, the user identification information and the device identification information for the electronic device, and software identification information for selected software, are sent to the server to request that the selected software be provided; the selected software provided from the server in response to the request is installed; the software identification information for the selected software, the user identification information, and the device identification information for the electronic device are sent to the server to request that a license required to run the selected software be generated based on predetermined license generating information and be provided to the electronic device; the selected software is run using the license; and a request is made to the server that the selected software be transferred to another electronic device. At the server, the software identification information for the selected software is registered in association with the user identification information and the device identification information for the electronic device on condition that the user identification information and the device identification information for the electronic device have been registered in association with each other; the electronic device is provided with the selected software; the license is generated when the software identification information for the selected software, the user identification information, and the device identification information for the electronic device have been registered in association with each other; and, upon a request to transfer the selected software to the another electronic device, the software identification information for the selected software and the user identification information and the device identification information registered in association with the software identification information are deleted, and the software identification information for the selected software is registered in association with the device identification information for the another electronic device and the user identification information.

The present invention, in another aspect thereof, provides an apparatus for providing software via a network to electronic devices, each of the electronic devices being identified by device identification information. The apparatus includes registering means for registering software identification information for selected software sent from an electronic device in association with user identification information identifying a user of the electronic device and device identification information for the electronic device on condition that the user identification information and the device identification information for the electronic device have been registered in association with each other; providing means for providing the selected software to the electronic device; generating means for generating license generating information for generating a license required to run the selected software when the software identification information for the selected software, the user identification information and the device identification information for the electronic device have been registered in association with each other; and transferring means for, upon a request to transfer the selected software to another electronic device, deleting the software identification information for the selected software and the user identification information and the device identification information registered in association with the software identification information, and registering the software identification information for the selected software in association with device identification information for the another electronic device and the user identification information.

The present invention, in another aspect thereof, provides a method for providing software via a network to electronic devices, each of the electronic devices being identified by device identification information. The method includes registering software identification information for selected software sent from an electronic device in association with user identification information identifying a user of the electronic device and device identification information for the electronic device on condition that the user identification information and the device identification information for the electronic device have been registered in association with each other; providing the selected software to the electronic device; generating license generating information for generating a license required to run the selected software when the software identification information for the selected software, the user identification information, and the device identification information for the electronic device have been registered in association with each other; and, upon a request to transfer the selected software to another electronic device, deleting the software identification information for the selected software and the user identification information and the device identification information registered in association with the software identification information, and registering the software identification information for the selected software in association with device identification information for the another electronic device and the user identification information.

The present invention, in another aspect thereof, provides a recording medium having recorded thereon a computer readable program for providing software via a network to electronic devices, each of the electronic devices being identified by device identification information. The program includes controlling registration of software identification information for selected software sent from an electronic device in association with user identification information identifying a user of the electronic device and device identification information for the electronic device, the software identification information for the selected software being registered when the user identification information and the device identification information for the electronic device have been registered in association with each other; controlling provision of the selected software to the electronic device; controlling generation of license generating information for generating a license required to run the selected software, the license generating information being generated when the software identification information for the selected software, the user identification information, and the device identification information for the electronic device have been registered in association with each other; and controlling deletion of the software identification information for the selected software and the user identification information and the device identification information registered in association with the software identification information, and registration of the software identification information for the selected software in association with device identification information for another electronic device and the user identification information, the deletion and the registration being executed upon a request to transfer the selected software to the another electronic device.

The present invention, in another aspect thereof, provides a system for providing software via a network to electronic devices, each of the electronic devices being identified by device identification information. The system includes a processor operable to execute instructions; and instructions. The instructions include registering software identification information for selected software sent from an electronic device in association with user identification information identifying a user of the electronic device and device identification information for the electronic device on condition that the user identification information and the device identification information for the electronic device have been registered in association with each other; providing the selected software to the electronic device; generating license generating information for generating a license required to run the selected software when the software identification information for the selected software, the user identification information, and the device identification information for the electronic device have been registered in association with each other; and, upon a request to transfer the selected software to another electronic device, deleting the software identification information for the selected software and the user identification information and the device identification information registered in association with the software identification information, and registering the software identification information for the selected software in association with device identification information for the another electronic device and the user identification information.

According to the software providing apparatus, method, recording medium, and system of the present invention, software identification information for selected software, sent from an electronic device, is registered in association with user identification information identifying a user of the electronic device and device identification information for the electronic device on condition that the user identification information and the device identification information for the electronic device have been registered in association with each other. The selected software is provided to the electronic device. License generating information for generating a license required to run the selected software is generated when the software identification information for the selected software, the user identification information, and the device identification information for the electronic device have been registered in association with each other. Upon a request to transfer the selected software to another electronic device, the software identification information for the selected software and the user identification information and the device identification information registered in association with the software identification information are deleted, and the software identification information for the selected software is registered in association with device identification information for the another electronic device and the user identification information.

The present invention, in another aspect thereof, provides a system for providing software, including a server operable to provide software via a network to electronic devices; and electronic devices, each of the electronic devices being identified by device identification information registered in association with user identification information identifying a user of the electronic device. Each of the electronic devices includes software requesting means for requesting selected software by sending software identification information for the selected software to the server; receiving means for receiving the selected software from the server; license requesting means for requesting a license for running the selected software; and change-requesting means for issuing an electronic-device changing request so that another electronic device different from the electronic device will be allowed to run the selected software. The server includes sending means for sending the selected software to the electronic device; issuing means for issuing the license for running the selected software; and changing means for executing an electronic-device changing operation so that the another electronic device will be allowed to run the selected software.

The present invention, in another aspect thereof, provides an apparatus for providing software via a network to electronic devices, each of the electronic devices being identified by device identification information. The apparatus includes storage means for storing device identification information for an electronic device and user identification information identifying a user of the electronic device in association with each other; receiving means for receiving software identification information for selected software from the electronic device; software sending means for sending the selected software identified by the software identification information to the electronic device; issuing means for issuing a license that allows the electronic device to run the selected software; and changing means for receiving a changing request and for executing a changing operation so that another electronic device will be allowed to run the selected software using the license.

The present invention, in another aspect thereof, provides a method for providing software via a network to electronic devices, each of the electronic devices being identified by device identification information. The method includes storing device identification information for an electronic device and user identification information identifying a user of the electronic device in association with each other in a storage unit; receiving software identification information for selected software from the electronic device; sending the selected software identified by the software identification information to the electronic device; issuing a license that allows the electronic device to run the selected software; and receiving a changing request and executing a changing operation so that another electronic device will be allowed to run the selected software using the license.

According to the present invention, a single piece of software can be run on a plurality of electronic devices registered in association with the same user identification information.

### BRIEF DESCRIPTION OF THE DRAWINGS

FIG. 1 is a diagram showing an example configuration of a software providing system according to the related art;

FIG. 2 is a diagram showing an example configuration of a software providing system according to the present invention;

FIG. 3 is block diagram showing an example configuration of the client device shown in FIG. 2;

FIG. 4 is block diagram showing an example configuration of another client device shown in FIG. 2;

FIG. 5 is a diagram showing an example configuration of the software providing server shown in FIG. 2;

FIG. 6 is a flowchart showing a process that is executed when the client device shown in FIG. 2 is purchased;

FIG. 7 is a diagram showing information stored in the storage unit shown in FIG. 3;

FIG. 8 is a diagram showing information registered in the database server shown in FIG. 2;

FIG. 9 is a flowchart showing a software purchasing process;

FIG. 10 is another diagram showing information registered in the database server shown in FIG. 2;

FIG. 11 is a diagram showing information stored in the license server shown in FIG. 2;

FIG. 12 is another diagram showing information stored in the storage unit shown in FIG. 3;

FIG. 13 is a diagram showing the data structure of an installation file;

FIG. 14 is a flowchart showing a process for executing purchased software;

FIG. 15 is a flowchart showing a process for transferring software that has been purchased using a first client device to another client device;

FIG. 16 is another diagram showing information registered in the database server shown in FIG. 2; and

FIG. 17 is a diagram showing information stored in the storage unit shown in FIG. 4.

### DETAILED DESCRIPTION

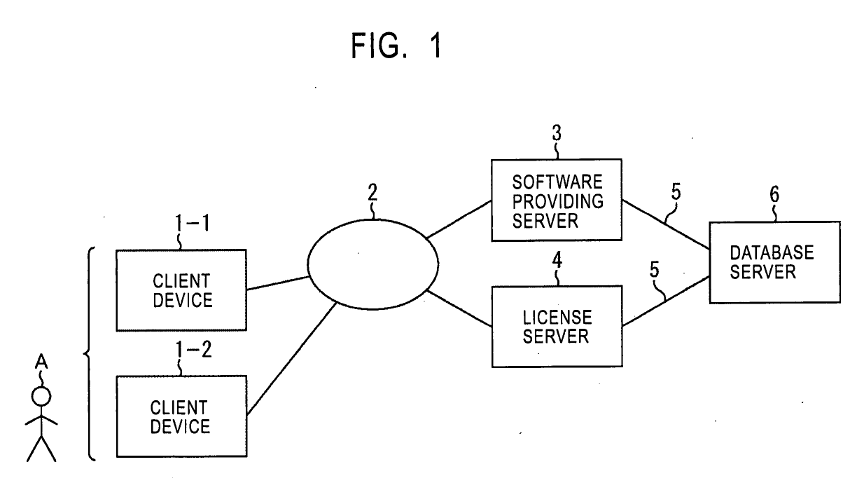

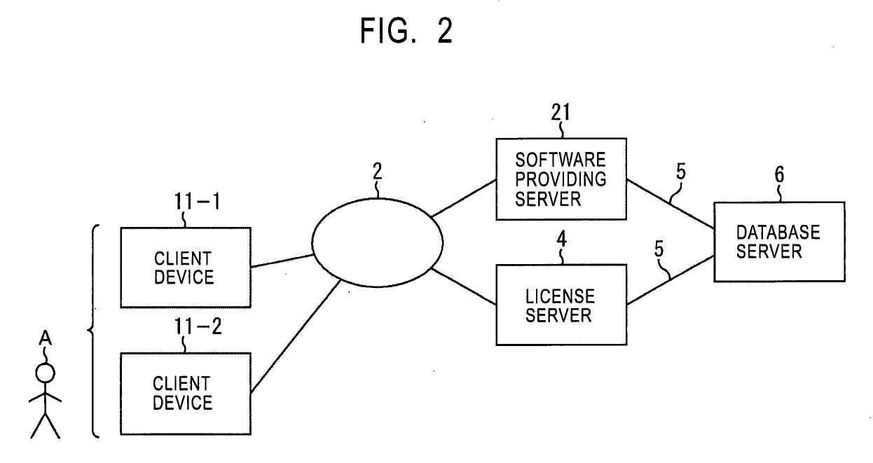

FIG. 2 shows an example configuration of a software providing system according to the present invention. The software providing system includes client devices 11-1 and 11-2 and a software providing server 21 instead of the client devices 1-1 and 1-2 and the software providing server 3 shown in FIG. 1. The software providing system shown in FIG. 2 is otherwise the same as the software providing system shown in FIG. 1.

The client devices 11-1 and 11-2, the software providing server 21, and the license server 4 communicate with each other, for example, exchange files, via the network 2, such as the Internet, based on predetermined protocols such as TCP/IP (Transmission Control Protocol/Internet Protocol). Furthermore, the software providing server 21 and the license server 4 exchange information as required with the database server 6 via the private lines 5. The client devices 11-1 and 11-2 (hereinafter simply referred to as client devices 11 except where distinction between the individual client devices is necessary) are owned by the same user A.

When software SA purchased by downloading via the network 2 from the software providing server 21 has been installed by the user A on a client device 11 of the user A, the client device 11 sends information including a device ID of the client device 11 and a user ID of the user A to the software providing server 21 via the network 2, requesting issuance of a license key that is needed for running the software A. The device ID refers to information that is unique to the hardware of the client device 11, such as a serial number of a CPU of the client device 11 or a product number stored in the BIOS (basic input/output system) of the client device 11.

The client device 11 runs the software SA using the license key provided via the network 2 from the license server 4 in response to the request for issuance of a license key.

The software providing server 21 sells various application software SA such as music-data recording software, image editing software, word processing software, and spreadsheet software. The client device 11 is allowed to purchase the software SA by downloading the software SA via the network 2.

When selling the software SA, the software providing server 21 authenticates the client device 11 wishing to purchase the software SA based on registered information (including a user ID and a device ID) of the client device 11 stored in the database server 6. When the authentication of the client device 11 has succeeded, the software providing server 21 requests the license server 4, via the network 2, to issue a license key.

The license server 4 issues a license key in response to the request from the software providing server 21, and sends the license key to the client device 11 via the network 2.

The database server 6 stores user information, including a user ID, device information including a device ID, and software information including the software ID of software that has been purchased, as registered information of the client device 11.

According to the software providing system, for example, it is possible to allow the client device 11-2 to run the software SA that the client device 11-1 of the same user is allowed to run. This feature will be described later.

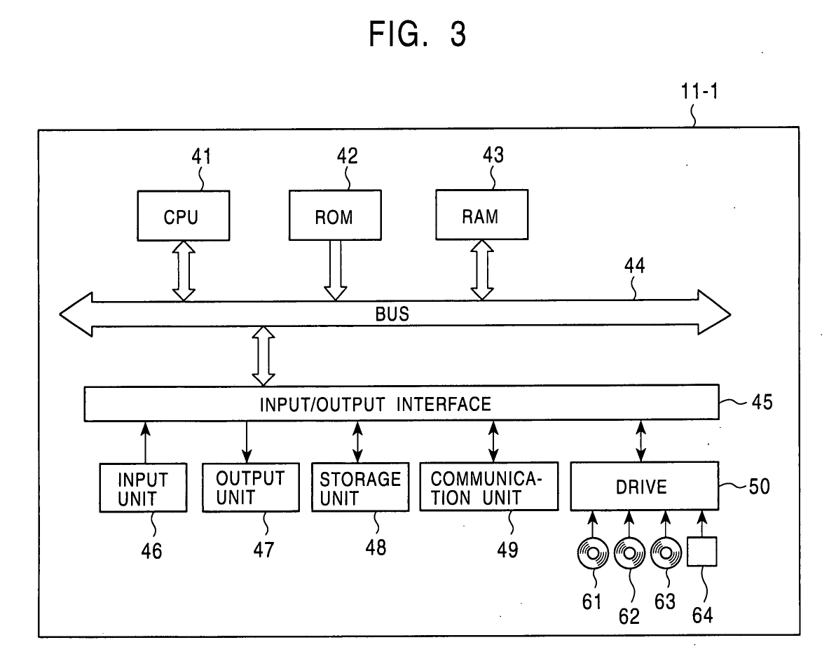

FIG. 3 shows an example configuration of the client device 11-1.

A CPU 41 executes various processes according to software loaded in a RAM 43 from a ROM 42 or from a storage unit 48. The RAM 43 also stores, as required, data needed by the CPU 41 for executing various processes.

The CPU 41, the ROM 42, and the RAM 43 are connected to each other via a bus 44. Also, an input/output interface 45 is connected to the bus 44.

The input/output interface 45 is connected to an input unit 46 including, for example, a keyboard and a mouse; an output unit 47, including a speaker, a display, such as a CRT (cathode ray tube) display or an LCD (liquid crystal display), or the like; the storage unit 48; and a communication unit 49, such as a modem or a terminal adaptor. The storage unit 48 stores predetermined information, such as the user ID of the user A, as will be described later. The communication unit 49 carries out communications via the network 2.

Furthermore, a drive 50 is connected to the input/output interface 45 as required. A magnetic disk 61, an optical disk 62, a magneto-optical disk 63, a memory card 64, etc. are loaded on the drive 50 as required, and a computer program read therefrom is installed on the storage unit 48 as required.

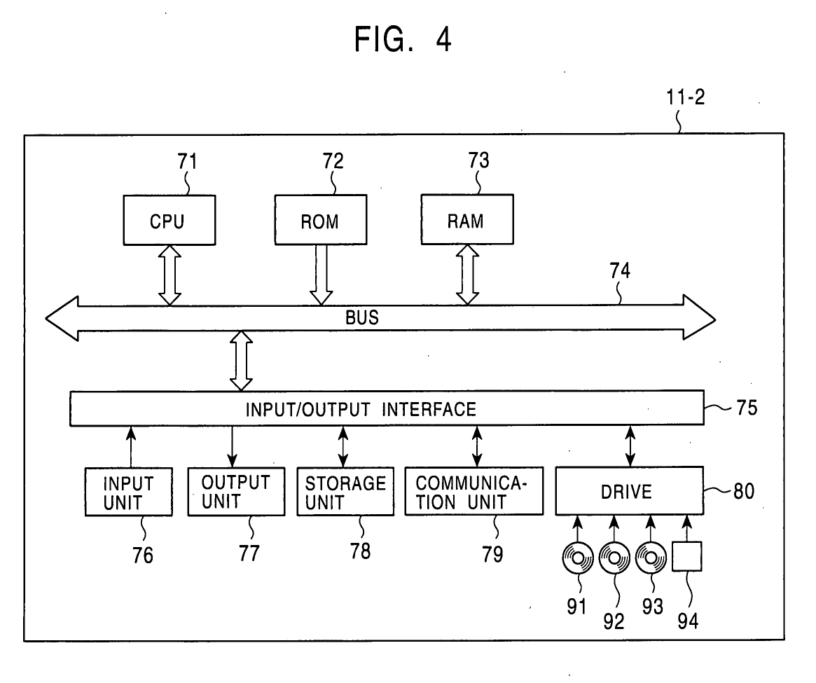

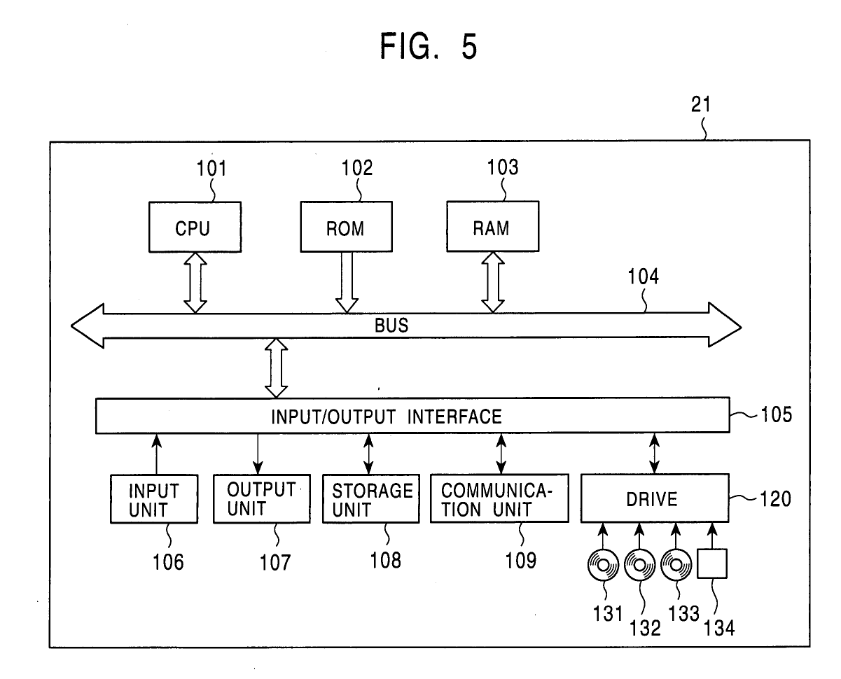

FIG. 4 shows an example configuration of the client device 11-2, and FIG. 5 shows an example configuration of the software providing server 21. These configurations are basically the same as the configuration of the client device 11-1, so that descriptions thereof will be omitted.

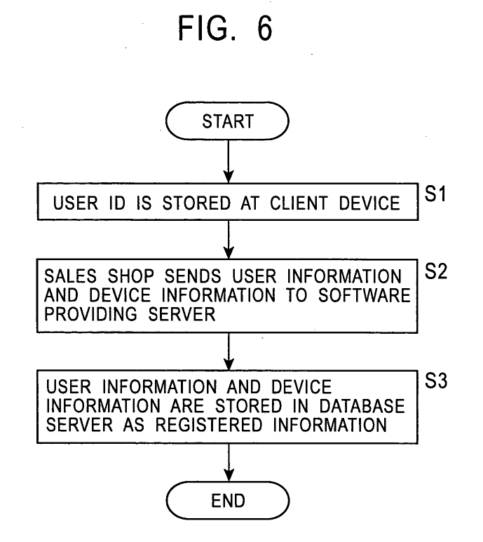

Next, a process that is executed when the client devices 11 are purchased will be described with reference to the flowchart shown in FIG. 6.

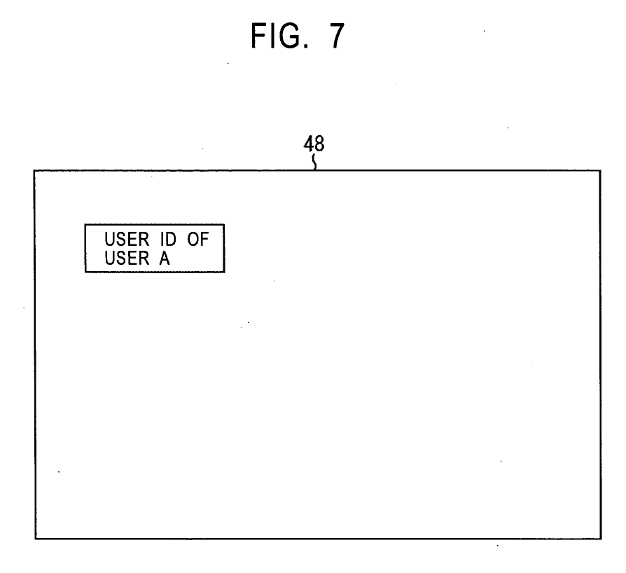

In step S1, when the user A purchases the client devices 11 at a sales shop (not shown), the sales shop assigns a user ID to the user A and stores the user ID in the client devices 11. Thus, for example, as shown in FIG. 7, the user ID of the user A is stored in the storage unit 48 of the client device 11-1. Also, although not shown, the user ID of the user A is stored in the storage unit 78 of the client device 11-2.

Then, in step S2, the sales shop sends user information including the user ID assigned to the user A in step S1 and an address of the user A, device information including device IDs unique to hardware of the client devices 11 (e.g., serial numbers of the CPUs 41 and 71) and manufacturer names to the software providing server 21.

In step S3, the software providing server 21 sends the user information and device information, transmitted from the sales shop, to the database server 6 via the private line 5. The database server 6 stores the user information and device information, transmitted from the software providing server 21, as registered information of the client devices 11.

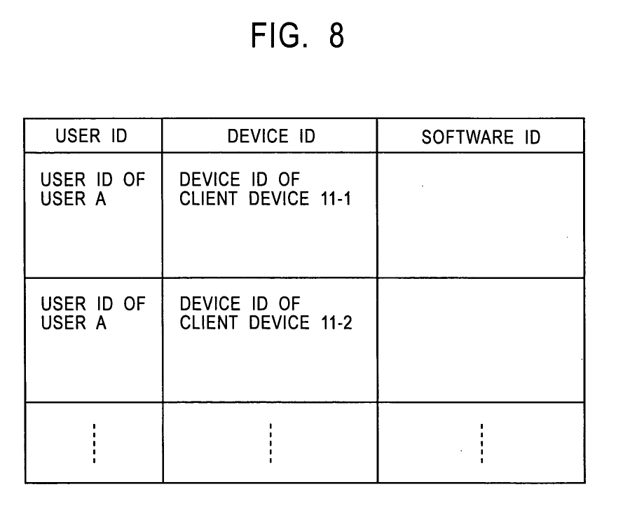

FIG. 8 shows part of the registered information stored in the database server 6 in the process described above. In the example shown in FIG. 8, the user ID of the user A and the device IDs of the client devices 11-1 and 11-2 are stored in association with each other. User information other than the user ID and device information other than the device IDs are stored separately in the database server 6 and can be retrieved based on the user ID and the device IDs, respectively.

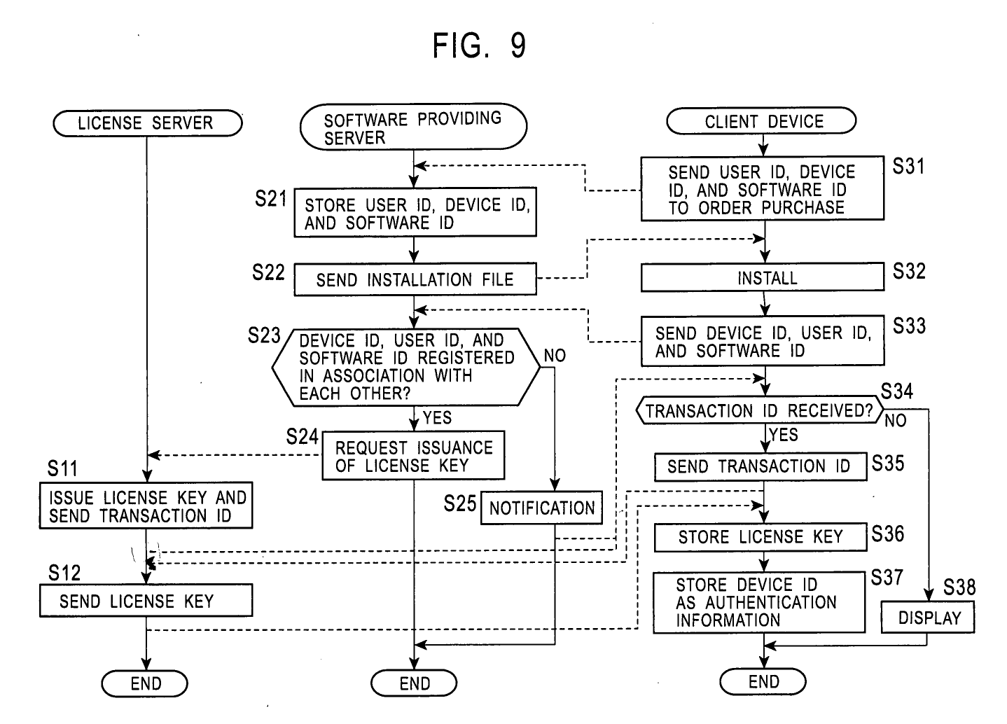

Next, a process that is executed when software SA is purchased by downloading will be described with reference to the flowchart shown in FIG. 9. In this example, it is assumed that the client device 11-1 purchases software SA1.

In step S31, the CPU 41 of the client device 11-1 sends the software ID of the software SA1 selected, the user ID of the user A, and the device ID of the client device 11-1 to the software providing server 21 via the communication unit 49, ordering purchase of the software SA1.

The software SA1 is selected on a software sales page that is separately supplied from the software providing server 21 and displayed on the display of the output unit 47 of the client device 11-1. When the software SA1 is selected on the page, the CPU 41 is allowed to obtain the software ID of the software SA1. The user ID of the user A is stored in the storage unit 48 of the client device 11-1 (in step S1 shown in FIG. 6), so that the CPU 41 reads the user ID therefrom. The device ID of the client device 11-1 is, for example, the serial number of the CPU 41, and is stored in an internal memory of the CPU 41, so that the CPU 41 reads the device ID therefrom.

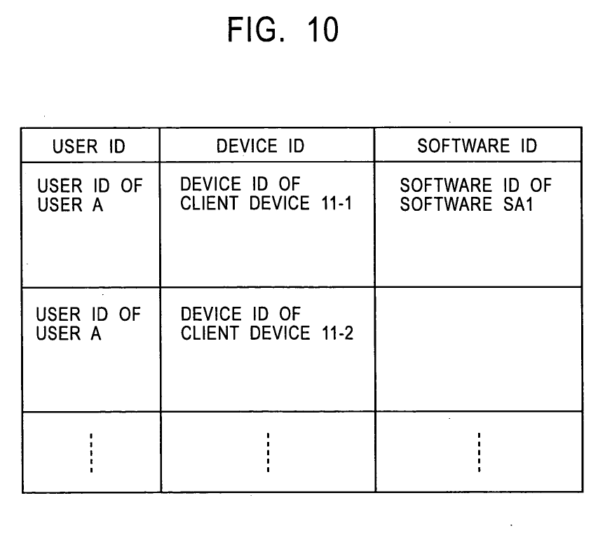

In step S21, the CPU 101 of the software providing server 21, upon receiving the order for purchasing the software SA1 from the client device 11-1, controls the communication unit 109 to send the information transmitted from the client device 11-1, including the software ID, the user ID, and the device ID, to the database server 6 via the private line 5. The database server 6 registers the software ID of the software SA1 in association with the user ID of the user A and the device ID of the client device 11-1, as shown in FIG. 10.

When the software ID of the software SA1 has been registered in the database server 6, it is determined that the software SA1 has been purchased by the user A, raising a need for charging. Processing for charging is executed separately, in which the user A is charged a price for the software SA1 purchased.

Referring back to FIG. 9, in step S22, the software providing server 21 sends an installation file for the software SA1, identified by the software ID transmitted from the client device 11-1, to the client device 11-1.

In step S32, the client device 11-1 installs the installation file transmitted from the software providing server 21.

The installation file includes an installation image obtained by compressing the software SA1 according to a predetermined algorithm. The client 11-1 is allowed to install the software SA1 by expanding the installation image.

In step S33, the client device 11-1 sends the device ID (the serial number of the CPU 41), the user ID of the user A, stored in the storage unit 48, and the software ID of the software SA1 installed in step S32 to the software providing server 21.

In step S23, the software providing server 21 carries out communication with the database server 6 via the private line 5 to determine whether the user ID, device ID and software ID transmitted from the client device 11-1 are registered in association with each other in the database server 6. If it is determined that the user ID, device ID, and software ID are registered in association with each other, the software providing server 21 proceeds to step S24.

In this example, since the user ID of the user A, the device ID of the client device 11-1, and the software ID of the software SA1 have been registered in association with each other in step S21 (FIG. 10), the software providing server 21 proceeds to step S24.

In step S24, the software providing server 21 sends information indicating a destination to which a license key is to be delivered (the client device 11-1), license generating information needed for generating a license key (including the software ID of the software SA1), etc. to the license server 4, requesting issuance of a license key.

If it is determined in step S23 that the user ID, device ID, and software ID are not registered in association with each other, the software providing server 21 proceeds to step S25, sending a predetermined error message to the client device 11-1.

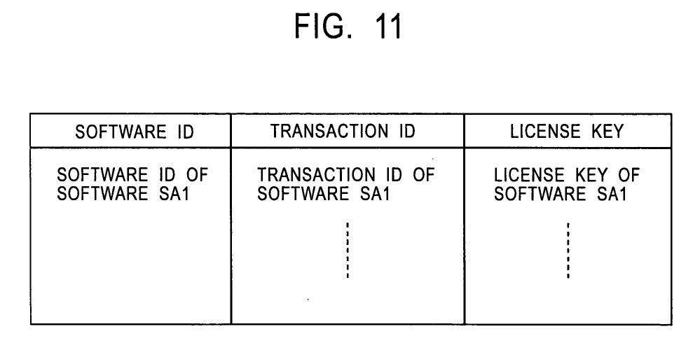

In step S11, the license server 4, in response to the request from the software providing server 21 to issue a license key, issues a license key using the license generating information transmitted from the software providing server 21, generates a transaction ID of the license key, and stores the license key and transaction ID together with the software ID of the software SA1, as shown in FIG. 11. Furthermore, the license server 4 sends the transaction ID to the client device 11-1.

In step S34, the client device 11-1 determines whether the transaction ID or an error message has been received from the license server 4. If it is determined that a transaction ID has been received, the client device 11-1 proceeds to step S35, sending (returning) the transaction ID to the license server 4.

In step S12, the license server 4, upon receiving the transaction ID transmitted from the client device 11-1, sends the license key stored in association with the transaction ID to the client device 11-1.

In step S36, the client device 11-1 stores the license key transmitted from the license server 4. In step S37, the client device 11-1 stores its own device ID (the serial number of the CPU 41) as authentication information.

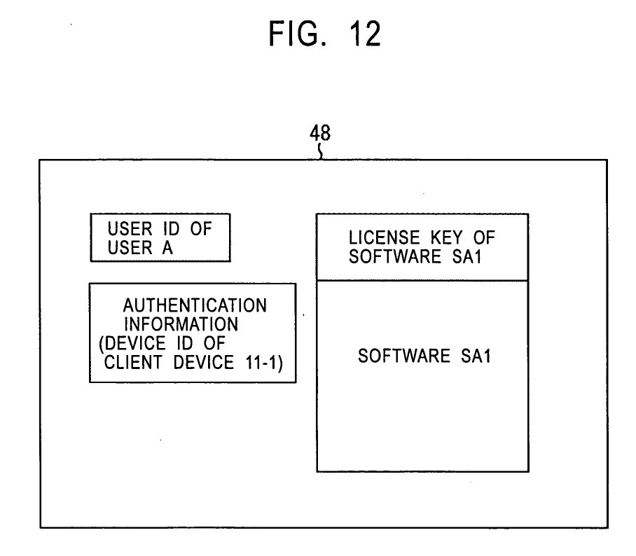

That is, at this time, items that have been stored in the storage unit 48 of the client device 11-1 include the software SA1 stored in step S32, the license key of the software SA1 stored in step S36, and the authentication information (the device ID of the client device 11-1) stored in step S37, as well as the user ID of the user A, stored at the time of purchase of the client device 11-1, as shown in FIG. 12.

Referring back to FIG. 9, if it is determined in step S34 that an error message has been received, that is, a transaction ID has not been received, the client device 11-1 proceeds to step S38, displaying a message to that effect on the display of the output unit 47.

The software SA1 is purchased in the manner described above.

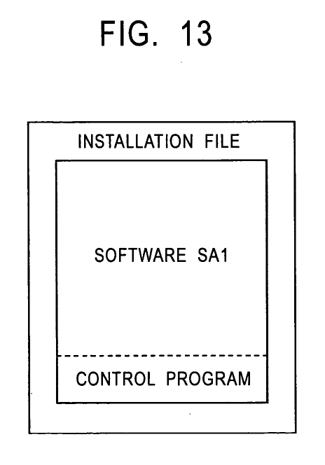

For example, the processing in steps S31 to S38 at the client device 11 may be executed by the CPU 41 according to a predetermined program. Alternatively, regarding the processing in steps S32 to S38, an installation file including the software SA proper and a control program as shown in FIG. 13 may be sent to the client device 11-1 so that processing will be executed according to the control program activated when the software SA1 is installed in step S32. In yet another alternative, the control program may be stored in advance in the storage unit 48 when the client device 11-1 is sold.

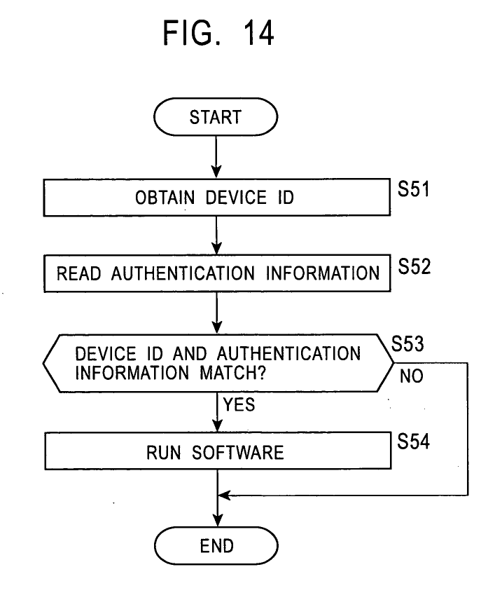

Next, a process that is executed when running the software SA1 that has been purchased on the client device 11-1 will be described with reference to the flowchart shown in FIG. 14.

When a command for running the software SA1 is input from the input unit 46 of the client device 11-1, in step S51, the CPU 41 obtains the device ID (the serial number of the CPU 41). In step S52, the CPU 41 reads the authentication information stored in step S37 shown in FIG. 9, from the storage unit 48.

In step S53, the CPU 41 of the client device 11-1 determines whether the device ID obtained in step S51 and the authentication information read in step S52 match. If matching is verified, the client device 11-1 proceeds to step S54.

In step S54, the client device 11-1 runs the software SA1 installed in step S32 shown in FIG. 9, using the license key stored in step S36.

If it is determined in step S53 that the device ID and the authentication information do not match, step S54 is skipped, so that the software SA1 is not activated.

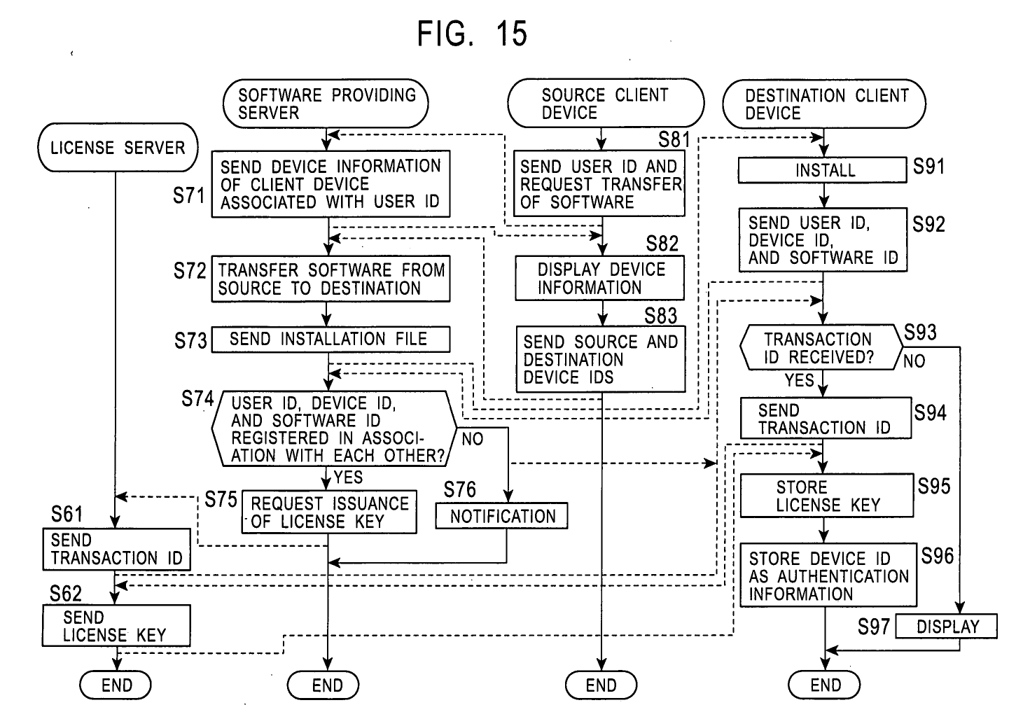

Next, a process that is executed for allowing the client device 11-2 to run the software SA1 that the client device 11-1 of the same user A has been allowed to run as described above will be described with reference to the flowchart shown in FIG. 15.

When the input unit 46 of the client device 11-1 is operated by the user A to input a command for transferring software, in step S81, the CPU 41 sends the user ID of the user A, stored in the storage unit 48, to the software providing server 21 via the communication unit 49, requesting transfer of the software.

In step S71, the CPU 101 of the software providing server 21, upon receiving the request from the client device 11-1 to transfer the software, controls the communication unit 109 to obtain from the database server 6 device information associated with the device IDs registered in association with the user ID of the user A, transmitted from the client device 11-1, and to send the device information to the client device 11-1.

In this example, since the registered information shown in FIG. 10 has been stored in the database server 6, the device information of the client devices 11-1 and 11-2 (the device IDs, device names, or the like of the client devices 11-1 and 11-2), whose device IDs have been registered in association with the user ID of the user A, are sent to the client device 11-1.

In step S82, the client device 11-1 displays a selection screen showing the device information transmitted from the software providing server 21, prompting the user A to select a source device and a destination device for transferring software.

When a source device and a destination device have been selected on the selection screen displayed in step S82, in step S83, the client device 11-1 sends the device IDs of the source device and the destination device to the software providing server 21. In this example, it is supposed that the client device 11-1 is selected as the source device and the client device 11-2 is selected as the destination device.

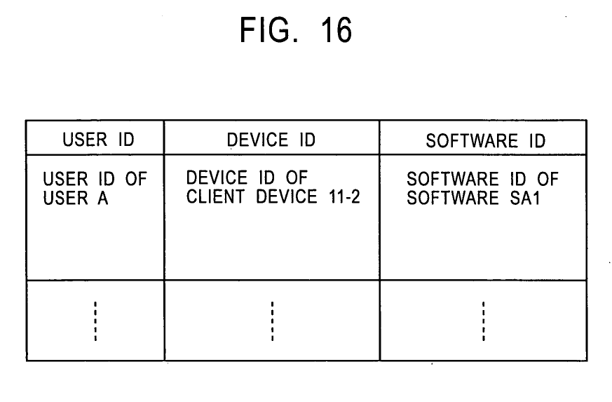

In step S72, the software providing server 21 carries out communication with the database server 6 to delete the device ID of the client device 11-1 serving as the source device, and the user ID of the user A and the software ID of the software SA1 registered in association therewith from the registered information stored in the database server 6 (FIG. 10), and to register the software ID of the software SA1 in association with the device ID of the client device 11-2 serving as the destination device and the user ID of the user A. That is, the registered information in the database server 6 becomes as shown in FIG. 16.

Since charging for the software SA1 has been executed in association with the processing in step S21 shown in FIG. 9 as described earlier, charging is not needed at this time.

Then, in step S73, the software providing server 21 sends an installation file for the software SA1, identified by the software ID registered in association with the device ID of the client device 11-2 in step S72, to the client device 11-2 serving as the destination device.

The processing in steps S91 to S97 at the client device 11-2 is basically the same as the processing in steps S32 to S38 at the client device 11-1, shown in FIG. 9, and the processing in steps S74 to S76 at the software providing server 21 is the same as the processing in steps S23 to S25 shown in FIG. 9, so that descriptions thereof will be omitted.

The processing in steps S61 and S62 at the license server 4 is basically the same as the processing in steps S11 and S12 in FIG. 9, so that detailed description thereof will be omitted. Note, however, that the license key of the software SA1 has already been issued in step S11 in FIG. 9, so that in step S61, a transaction ID stored in association with the software ID of the software SA1 is sent to the client device 11-2.

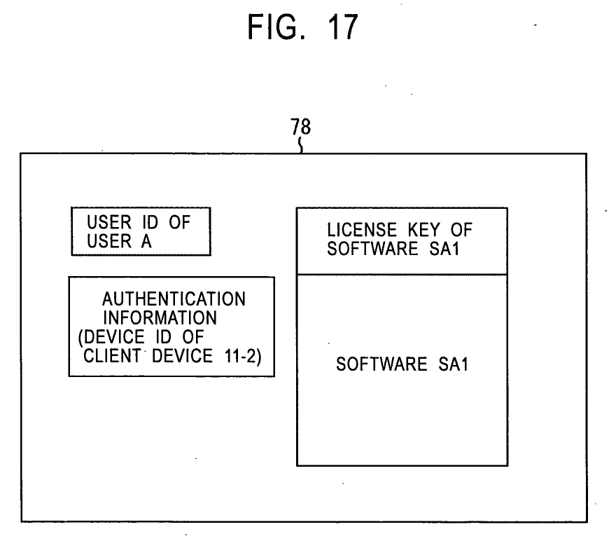

Thus, items stored in the storage unit 78 of the client device 11-2 include the user ID of the user A, the software SA1 stored in step S91, the license key of the software SA1 stored in step S95, and the authentication information (the device ID of the client device 11-2) stored in step S96, as shown in FIG. 17. That is, the client device 11-2 is allowed to activate and run the software SA1 according to the procedure shown in FIG. 14.

Since the user ID of the user A and the device ID of the client device 11-1 have been deleted from the registered information in step S72, when an attempt is made to purchase software via the client device 11-1, the software ID of software SA ordered for purchase is not registered in step S21 shown in FIG. 9, so that purchase of software via the client device 11-1 is prohibited.

The series of processes described above may be executed either by hardware or by software. When the series of processes is to be executed by software, a program that constitutes the software is installed from a recording medium on a computer embedded in special hardware or a general-purpose computer or the like that allows various functions to be executed with various programs installed thereon.

As shown in FIGS. 3, 4, and 5, the recording medium may be a packaged medium having a program recorded thereon, distributed separately from a computer to provide a user with the program, such as a magnetic disk 61, 91, or 131 (including a floppy disk), an optical disk 62, 92, or 132, a magneto-optical disk 63, 93, or 133, or a semiconductor memory 64, 94, or 134. Alternatively, the recording medium may be the ROM 42, 72, 102, or the storage unit 48, 78, or 108 having the program recorded thereon, distributed to the user as embedded in the computer.

Steps of the program provided using the recording medium may include processes that are executed in parallel or individually, as well as processes executed sequentially in the order described in this specification.

In this specification, a system refers to the entirety of an arrangement formed by a plurality of systems.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A system for providing software, comprising:
a server operable to provide software via a network to a plurality of electronic devices;
at least two electronic devices, each of the at least two electronic devices being identified by device identification information registered in association with user identification information identifying a single user of the at least two electronic devices;
each of the at least two electronic devices including:
first requesting means for sending the user identification information and the device identification information for the electronic device, and software identification information for selected software, to the server to request that the selected software be provided;
installing means for installing the selected software provided from the server;
second requesting means for sending the software identification information for the selected software, the user identification information, and the device identification information for the electronic device to the server to request that a license required to run the selected software be generated based on predetermined license generating information and be provided to the electronic device;
running means for running the selected software using the license; and
third requesting means for requesting that the server transfer the selected software to another of the at least two electronic devices; and
the server including:
registering means for registering the software identification information for the selected software in association with the user identification information and the device identification information for the electronic device on condition that the user identification information and the device identification information for the electronic device have been registered in association with each other;
providing means for providing the selected software to the electronic device;
generating means for generating the license when the software identification information for the selected software, the user identification information, and the device identification information for the electronic device have been registered in association with each other; and
transferring means for, upon a request by the third requesting means of the electronic device to transfer the selected software to the another electronic device, deleting the software identification information for the selected software and the user identification information and the device identification information registered in association with the software identification information, and registering the software identification information for the selected software in association with the device identification information for the another electronic device and the user identification information.

2. An apparatus for providing software via a network to electronic devices, each of the electronic devices being identified by device identification information, the apparatus comprising:
registering means for registering software identification information for selected software sent from an electronic device in association with user identification information identifying a user of the electronic device and device identification information for the electronic device on condition that the user identification information and the device identification information for the electronic device have been registered in association with each other;
providing means for providing the selected software to the electronic device;
generating means for generating license generating information for generating a license required to run the selected software when the software identification information for the selected software, the user identification information and the device identification information for the electronic device have been registered in association with each other; and
transferring means for, upon a request to transfer the selected software to another electronic device, deleting the software identification information for the selected software and the user identification information and the device identification information registered in association with the software identification information, and registering the software identification information for the selected software in association with device identification information for the another electronic device and the user identification information.

3. A method for providing software via a network to electronic devices, each of the electronic devices being identified by device identification information, the method comprising:
registering software identification information for selected software sent from an electronic device in association with user identification information identifying a user of the electronic device and device identification information for the electronic device on condition that the user identification information and the device identification information for the electronic device have been registered in association with each other;
providing the selected software to the electronic device;
generating license generating information for generating a license required to run the selected software when the software identification information for the selected software, the user identification information and the device identification information for the electronic device have been registered in association with each other; and
upon a request to transfer the selected software to another electronic device, deleting the software identification information for the selected software and the user identification information and the device identification information registered in association with the software identification information, and registering the software identification information for the selected software in association with device identification information for the another electronic device and the user identification information.

4. A recording medium having recorded thereon a computer readable program for providing software via a network to electronic devices, each of the electronic devices being identified by device identification information, the program comprising:
controlling registration of software identification information for selected software sent from an electronic device in association with user identification information identifying a user of the electronic device and device identification information for the electronic device, the software identification information for the selected software being registered when the user identification information and the device identification information for the electronic device have been registered in association with each other;
controlling provision of the selected software to the electronic device;
controlling generation of license generating information for generating a license required to run the selected software, the license generating information being generated when the software identification information for the selected software, the user identification information and the device identification information for the electronic device have been registered in association with each other; and
controlling deletion of the software identification information for the selected software and the user identification information and the device identification information registered in association with the software identification information, and registration of the software identification information for the selected software in association with device identification information for another electronic device and the user identification information, the deletion and the registration being executed upon a request to transfer the selected software to the another electronic device.

5. A system for providing software via a network to electronic devices, each of the electronic devices being identified by device identification information, the system comprising:
a processor operable to execute instructions; and
instructions, the instructions including:
registering software identification information for selected software sent from an electronic device in association with user identification information identifying a user of the electronic device and device identification information for the electronic device on condition that the user identification information and the device identification information for the electronic device have been registered in association with each other;
providing the selected software to the electronic device;
generating license generating information for generating a license required to run the selected software when the software identification information for the selected software, the user identification information and the device identification information for the electronic device have been registered in association with each other; and
upon a request to transfer the selected software to another electronic device, deleting the software identification information for the selected software and the user identification information and the device identification information registered in association with the software identification information, and registering the software identification information for the selected software in association with device identification information for the another electronic device and the user identification information.

6. A system for providing software, comprising:
a server operable to provide software via a network to electronic devices; and
electronic devices, each of the electronic devices being identified by device identification information registered in association with user identification information identifying a user of the electronic device;
each of the electronic devices including:
software requesting means for requesting selected software by sending software identification information for the selected software to the server;
receiving means for receiving the selected software from the server;
license requesting means for requesting a license for running the selected software; and
change-requesting means for issuing an electronic-device changing request so that another electronic device different from the electronic device will be allowed to run the selected software; and
the server including:
sending means for sending the selected software to the electronic device;
issuing means for issuing the license for running the selected software; and
changing means for executing an electronic-device changing operation so that the another electronic device will be allowed to run the selected software.

7. An apparatus for providing software via a network to electronic devices, each of the electronic devices being identified by device identification information, the apparatus comprising:
storage means for storing device identification information for an electronic device and user identification information identifying a user of the electronic device in association with each other;
receiving means for receiving software identification information for selected software from the electronic device;
software sending means for sending the selected software identified by the software identification information to the electronic device;
issuing means for issuing a license that allows the electronic device to run the selected software; and
changing means for receiving a changing request and for executing a changing operation so that another electronic device will be allowed to run the selected software using the license.

8. The software providing apparatus according to claim 7, wherein when the receiving means has received the software identification information for the selected software, the storage means stores the software identification information for the selected software in association with the device identification information for the electronic device.

9. The software providing apparatus according to claim 7, wherein when the changing request has been received from the electronic device, the device identification information for the electronic device stored in the storage means is replaced with the device identification information for the another electronic device.

10. The software providing apparatus according to claim 7, wherein the receiving means receives the user identification information identifying the user of the electronic device and the device identification information for the electronic device together with the software identification information for the selected software, and the software sending means carries out authentication based on the user identification information and the device identification information for the electronic device before sending the selected software to the electronic device.

11. The software providing apparatus according to claim 7, wherein the changing means receives the user identification information identifying the user of the electronic device and the device identification information for the electronic device together with the changing request, and carries out authentication based on the user identification information and the device identification information for the electronic device before executing the changing operation.

12. The software providing apparatus according to claim 7, wherein the software providing means sends the selected software to the another electronic device when the changing operation has been executed.

13. A method for providing software via a network to electronic devices, each of the electronic devices being identified by device identification information, the method comprising:
storing device identification information for an electronic device and user identification information identifying a user of the electronic device in association with each other in a storage unit;
receiving software identification information for selected software from the electronic device;
sending the selected software identified by the software identification information to the electronic device;
issuing a license that allows the electronic device to run the selected software; and
receiving a changing request and executing a changing operation so that another electronic device will be allowed to run the selected software using the license.

14. The software providing method according to claim 13, wherein when the software identification information for the selected software has been received from the electronic device, the software identification information for the selected software is stored in the storage unit in association with the device identification information for the electronic device.

15. The software providing method according to claim 13, wherein the device identification information for the electronic device stored in the storage unit is replaced with the device identification information for the another electronic device when the changing request has been received from the electronic device.

16. The software providing method according to claim 13, wherein the user identification information identifying the user of the electronic device and the device identification information for the electronic device are received together with the software identification information for the selected software, and authentication is carried out based on the user identification information and the device identification information for the electronic device before sending the selected software to the electronic device.

17. The software providing method according to claim 13, wherein the user identification information identifying the user of the electronic device and the device identification information for the electronic device are received together with the changing request, and authentication is carried out based on the user identification information and the device identification information for the electronic device before executing the changing operation.

18. The software providing method according to claim 13, wherein the selected software is sent to the another electronic device when the changing operation has been executed.
